(19) United States
(12) Patent Application Publication
(10) Pub. No.: US 2007/0056947 A1
(43) Pub. Date: Mar. 15, 2007

(54) System and sensor for remote defrost activation

(75) Inventor: Kevin A. Damian, Buxton, ME (US)

Correspondence Address: KEVIN FARRELL;PIERCE ATWOOD, ONE NEW HAMPSHIRE AVENUE, PORTSMOUTH, NH, 03801, US

(73) Assignee: Control Devices, Inc., Standish, ME (US)

(21) Appl. No.: 11/227,281

(22) Filed: Sep. 15, 2005

(51) Int. Cl. B60L 1/02

(52) U.S. Cl. 219/203

(57) ABSTRACT

A system and a sensor usable for the automated activation of a defrosting mechanism; particularly the automated defrost of a vehicle window. Further, the sensor is adapted for the detection and measurement of changes in the dielectric constant of a dielectric disposed on a surface. Further still, the sensor is adapted for detecting changes in the phase changes of water, i.e. detecting if and when liquid water becomes frozen into frost, ice or snow. The sensor is coupled to a processor and various defrosting means for automatically defrosting vehicle windows in response to a remote signal, such as that provided by a keyless entry or remote starter.

### BACKGROUND OF THE PRESENT INVENTION

1. Field of the Invention

The present invention relates generally to the use of electronics for measuring the presence of moisture, and particularly to the field of automation of the defrost mechanism in contemporary automobiles.

2. History of the Related Art

Vehicle drivers, particularly those who reside in the less temperate climates, are very familiar with the sight of frost, ice and snow on their windows during the winter months. While several advances over the years have made the defrosting process more amenable to drivers, most can still be found routinely scraping ice from their windows as the engine warms and the electrical systems charge. In some locations, such as the northern United States, the winters are cold enough to either necessitate a garage or require that the vehicle warm itself while the driver patiently awaits indoors.

Many vehicle manufactures, original equipment manufacturers (OEMs), and aftermarket services have introduced remote car starters into the market to somewhat streamline this winter ritual. In a typical remote starter system, the driver presses a button on a small transmitter that sends a signal, such as an RF signal, to a sensor in the vehicle that then automatically starts the engine. Thus, a driver can begin the defrost process from the comfort and warmth of his or her own home or office without having to venture into the cold. Although remote car starters are certainly an improvement, they are essentially passive in nature. Specifically, current remote starters cannot control the temperature within the vehicle, nor are they presently adapted to control any of the vehicle's electrical systems save for the engine starter itself. As such, while the engine is warming, the remaining vehicle systems may be inoperable or even working counter to the warming process, i.e. cooling down the interior of the vehicle.

In particular, people familiar with cold climates are also familiar with the effects of introducing a warm body into a vehicle's cold interior. The breath from the driver and any passengers will soon condense on the interior of the vehicle's windows, obscuring the visibility of all those present. Unfortunately, cold winters also correlate to hazardous driving conditions precipitated by the weather, and so any additional moisture on the windows will only amplify these problems. The typical solution to frost or fog on the interior of windows is to activate some kind of defrost mechanism, generally utilizing warm air from the engine or resistive heating from wires disposed within the glass.

While current defrost mechanisms are capable of improving driver visibility, it is also the case that many drivers find themselves on the highway with little or no visibility because the windows have not sufficiently warmed prior to driving. Thus, in order to improve driver visibility and automotive safety, there is a need in the art for an automated and controlled system for activating a vehicle's defrosting mechanism. There is also a need in the art for such a system that can be easily integrated into OEM articles as well as aftermarket equipment. Moreover, there is a need in the art for a sensor that automatically determines the presence and degree of moisture present on a surface, such as a vehicle window. Finally, there is a need in the art for an integrated system and sensor that can be automatically activated, for example by a remote car starter.

### SUMMARY OF THE PRESENT INVENTION

The present invention includes a system and a sensor usable for the automated activation of a defrosting mechanism; particularly the automated defrost of a vehicle window. The present invention includes a sensor that is adapted for the detection and measurement of changes in the dielectric constant of a dielectric disposed on a surface. More particularly, the sensor of the present invention is adapted for detecting changes in the phase of water, i.e. detecting if and when liquid water becomes frozen into frost, ice or snow. As described below more fully, owing to the relationship between the dielectric constant of various phases of water and capacitance, the sensor of the present invention utilizes fringing-field capacitors to determine the critical phase change.

The sensor is incorporated into a system for automatically activating a vehicle defrost, wherein the system includes a processor and various defrosting means for eliminating any solid water from a vehicle window. The processor is responsive to remote starting, which is defined herein as the starting of a vehicle engine from outside the vehicle, such as by RF transmitter. The processor is further adapted for controlling a vehicle HVAC system, engine and any other electronic heating means that may be utilized in heating and defrosting a vehicle window. It is customary for the windshield of a vehicle to be defrosted by heated air passing through the HVAC system while the rear window is defrosted by electrical means. Accordingly, the processor of the present invention is adapted for the control and regulation of each of these defrosting means alone or in combination with one another.

In operation, the sensor includes a fringe effect capacitor that is disposed on or near the surface to be defrosted. In preferred embodiments, the sensor is disposed between two panes of glass that form a window in the vehicle, such as the windshield. The capacitor of the sensor is particularly shaped and sized in order to optimally determine the dielectric constant of the water on the surface through changes in the capacitance. As discussed more fully below, changes in temperature correlate to the capacitor requiring more or less voltage to maintain a uniform potential difference, which in turn correlates to a change in the dielectric constant of the water on the surface. In particular, if any water on a vehicle window changes from liquid to solid form, its dielectric constant will also change causing a dramatic effect on the capacitance of the sensor of the present invention. In such cases, the processor is adapted to respond to signals indicative of a change in phase and automatically activate the vehicle defrosting means.

In summary, the present invention provides a novel and innovative sensor and system that can be readily incorporated into new and aftermarket vehicle systems. Those drivers in less temperate climates will also appreciate that the present invention is adapted for use in a remote starting system, thus permitting a user to defrost the windows of his or her vehicle without having to sit idly in the cold. These and various other features and benefits of the present invention are discussed more fully below with reference to the following drawings.

### BRIEF DESCRIPTION OF THE DRAWINGS

FIG. 1 is a schematic representation of the remote defrost activation system of the present invention.

FIG. 2 is a plan view of a typical automotive vehicle incorporating the remote defrost activation system of the present invention.

FIG. 3 is a cross-sectional view of a defrost activation sensor in accordance with the present invention.

FIG. 4 is a graphical representation of the relationship between time and temperature usable by a processor according to the present invention.

FIG. 5 is a graphical representation of the relationship between temperature and capacitance usable by a processor according to the present invention.

FIG. 6 is a plan view of the defrost activation sensor in accordance with one embodiment of the present invention.

FIG. 7 is a plan view of the defrost activation sensor in accordance with another embodiment of the present invention.

FIG. 8 is a plan view of the defrost activation sensor in accordance with another embodiment of the present invention.

### DETAILED DESCRIPTION OF THE PREFERRED EMBODIMENTS

The present invention includes a system and sensor for the remote activation of a defrosting mechanism in a motor vehicle, such as, for example heated air or electronic heating. In particular, the present invention includes a sensor that is adapted to detect the temperature of moisture impending on a surface, such a quantity of frost, ice or snow settling on a windshield or rear window. By integrating the sensor of the present invention to a comprehensive automatic defrost activation system, the present invention improves upon the state of the art in numerous fashions as described in detail below.

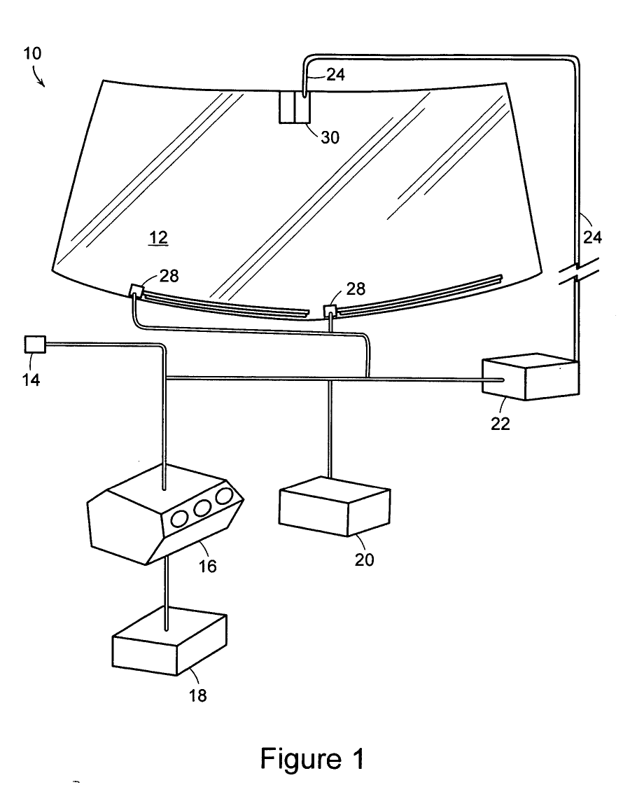

FIG. 1 is a schematic representation of the remote defrost activation system 10 of the present invention. The system 10 of the present invention includes a sensor 30 that is coupled to, in contact with, or embedded in a surface 12. The surface 12 shown in FIG. 1 represents a piece of glass, such as that found in an automobile windshield. It should be understood that the sensor 30 could also be disposed in a rear window or any other suitable surface found on a vehicle. It should further be understood that the system 10 of the present invention could also incorporate multiple sensors 30 disposed in or on various surfaces of a vehicle.

The system 10 further includes a receiver 14 that is configured for receiving a remote signal and converting that signal into an electronic signal to be communicated to a processor 22. The receiver 14 is preferably configured for the receipt of incoming radiation, such as infrared or radiofrequency signals emitted by a handheld transmitter (not shown). In preferred embodiments, the receiver 14 is an RF receiver as typically used in the art of remote car starters.

The processor 22 is a central component of the system 10, and it includes the necessary hardware and operational software to perform the tasks set forth below. Those skilled in the art of electronics, particularly as it relates to automotive control units, will readily appreciate the functional requirements of the processor 22. The processor 22 is coupled to an engine 16 and heating, venting and air conditioning (HVAC) system 18. The engine 16 and HVAC system 18 are connected to each other in a manner familiar to those skilled in the automotive arts, such that heat generated by the engine 16 is utilized by the HVAC system 18 for heating, ventilating or cooling the interior of the vehicle.

The processor 22 is further coupled to an electronic heater 20 which functions to heat various surfaces of the vehicle through resistive heating, i.e. passing electrical current through resistive wires, such as the case in rear window defrost mechanisms. Although the electronic heater 20 is schematically depicted in FIG. 1, as used herein the term electronic heater 20 includes the necessary power generation, distribution and heating means, including any components that may be embedded within or disposed upon a glass surface of the vehicle. The processor 22 is also coupled to and may activate and control a pair of wipers 28 in response to a moisture measurement on the surface 12 or in response to activation of the defrosting means, as discussed further below.

The processor 22 and the sensor 30 are coupled by a signal carrier 24 that is in direct electrical communication with the sensor 30, as discussed further below. The signal carrier 24 is responsible for providing electrical current to the sensor 30 during its operation as well as transmitting data generated by the sensor 30 back to the processor 22. Accordingly, the signal carrier 24 depicted herein is adapted for performing numerous functions, all of which can be readily engineered by those skilled in the art.

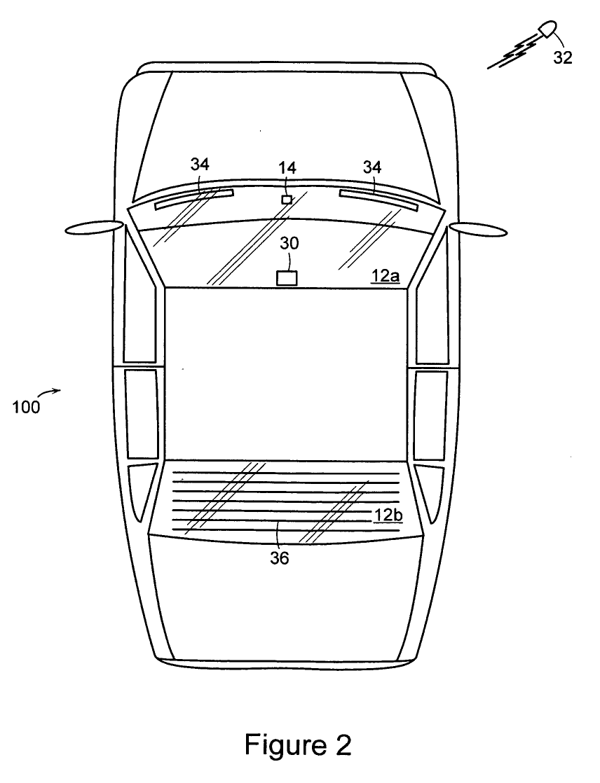

FIG. 2 is a plan view of a typical automotive vehicle 100 incorporating the remote defrost activation system 10 of the present invention. The vehicle 100 includes a pair of surfaces 12a, 12b that are representative of a windshield 12a and a rear window 12b, each of which may be automatically defrosted in accordance with the present invention. A pair of vents 34 composing part of the HVAC system 18 (not shown) are preferably disposed directly adjacent to and generally beneath the interior surface of the windshield 12a, as is commonly practiced. The rear window 12b contains or is otherwise in contact with a set of resistive heaters 36 that compose part of the electronic heater 20 (not shown). The resistive heaters 36 are preferably thin wires that are not obtrusive to one's view, yet have sufficient resistance to generate enough heat to defrost the rear window 12b.

In operation, a user handling a remote control 32 activates the system 10 of the present invention by pressing a button or otherwise generating a signal in the direction of the vehicle 100. As noted above, the remote control 32 and receiver 14 are preferably of the RF type, although other systems of remote communication are contemplated herein as well. The receiver 14 is preferably disposed in a location that minimizes the signal interference from outside objects. As shown in FIG. 2, the receiver 14 is located beneath the windshield 12a between the vents 34. However, it is understood that the receiver 14 could be disposed at any location in the vehicle such that it can readily communicate with the remote control 32 and the processor 22 of the system 10.

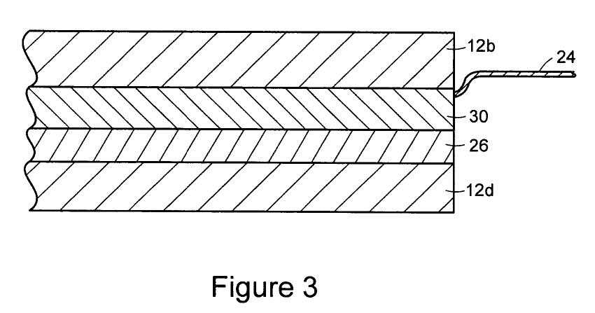

FIG. 3 is a cross-sectional view of a portion of the system 10 including the defrost activation sensor 30. As noted above, the sensor 30 is preferably disposed within a surface 12 of the vehicle. In particular, because of the sensitive nature of the sensor 30, it is most preferred that the sensor 30 be disposed between a pair of surfaces 12c, 12d, which surfaces 12c, 12d together form a window of a vehicle. As shown in FIG. 3, the sensor 30 is disposed on a substrate 26, which is preferably an optically opaque material that can be readily disposed between the pair of surfaces 12c, 12d without obscuring one's view. The signal carrier 24 is shown in communication with the sensor 30. As previously noted, the signal carrier 24 is best understood in terms of the functions it performs, including providing power to the sensor 30 and transmitting the sensor 30 data to the processor 22.

The sensor 30 operates on the principles governing the interaction between electric fields and dielectric materials. In particular, the sensor 30 is adapted for creating and maintaining a spatially variable but temporally constant electric field between two opposing poles. Based on the known reaction between capacitance and electric fields, the processor 22 can establish a normal or base capacitance measured by the sensor 30.

A known feature of so-called parallel plate capacitors, of which the sensor 30 of the present invention is a variation, is the fringe field effect. That is, although the electric field between parallel plate capacitors is generally uniform, at the edge of the parallel plates the field becomes non-uniform. This fringing field is responsible for the action on a dielectric that moves the dielectric into the uniform, parallel field portion of the capacitor. As a dielectric moves within a fringe-field capacitor, the battery must do some work in order to maintain the capacitor's potential. This amount of work is proportional to the dielectric constant of the dielectric, and thus a fringe-field capacitor can indirectly measure the dielectric constant of a dielectric by measuring the required potential change to maintain the capacitance.

It is also known that the thickness of the dielectric must be related to the thickness of the electrodes as well as the gap between the electrodes. Smaller electrodes with lesser gaps are preferred for measuring the dielectric constant of a relatively thin dielectric. Similarly, larger electrodes with greater gaps are preferred for measuring the dielectric constant of a relatively thick dielectric. The present invention provides for differing shapes and sizes of the electrode configurations, as the present invention is designed to confirm the presence of moisture on a surface, which may include thin layers of frost as well as thicker layers of ice and snow. The specific physical and electrical properties of the present invention are discussed below.

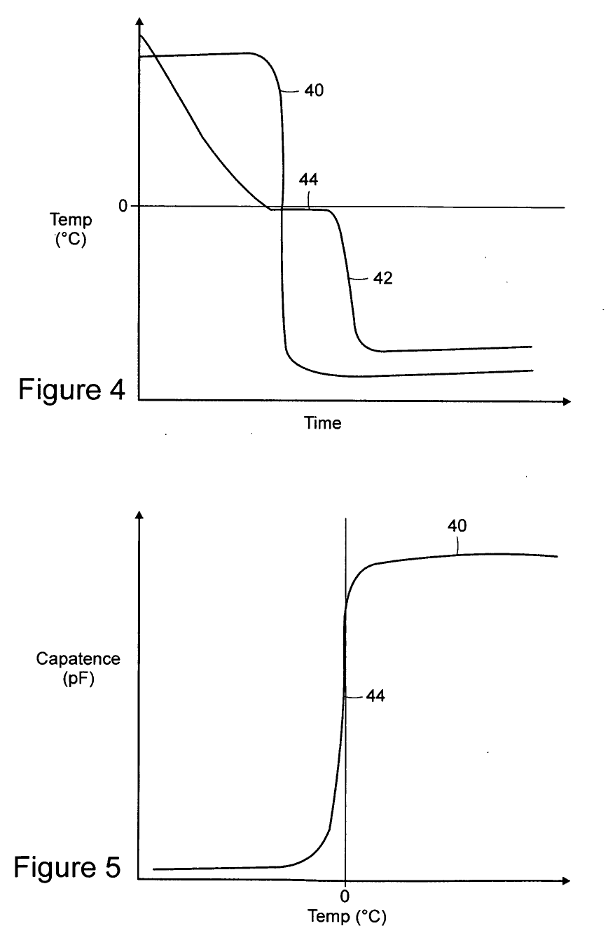

FIG. 4 is a graphical representation of the relationship between time and water temperature as measured by a sensor 30 of the present invention. A capacitance 40 and a water temperature 42 are shown decreasing with substantial regularity as time increases and the temperature of the overall system drops. A plateau 44 is indicative of the latent heat of the water as it changes phases between a liquid and a solid. Following the plateau 44, the water temperature 42 decreases rapidly as the water solidifies and the newly formed ice comes into equilibrium with the system temperature. The curve representing the capacitance 40 is much steeper at the phase transition, owing to the fact that the dielectric constant of water is approximately 25 times greater than that of ice. Also, the latent heat aspects of the phase transition do not affect the capacitance 40 as measured, because the variable controlling the capacitance 40 is the dielectric constant, which decreases at a substantially faster rate than the latent heat is removed from the water.

This aspect of the present invention is also shown in FIG. 5, which is a graphical representation of the relationship between temperature and capacitance in accordance with the sensor 30 of the present invention. As shown, the capacitance 40 of the water increases dramatically as the temperature passes zero degrees Celsius and the water changes phases from solid to liquid. The plateau 44 is nondescript as indicated above. As such, it has been found that the sensor 30 of the present invention can detect rapid phase changes in water through capacitance measurements, and therefore the sensor 30 and system 10 of the present invention will be optimally responsive to any temperature changes that may require activation of the defrosting means of the vehicle. As discussed in detail below, the sensor 30 can be configured in numerous fashions in order to further optimize the measurement capabilities of the present invention.

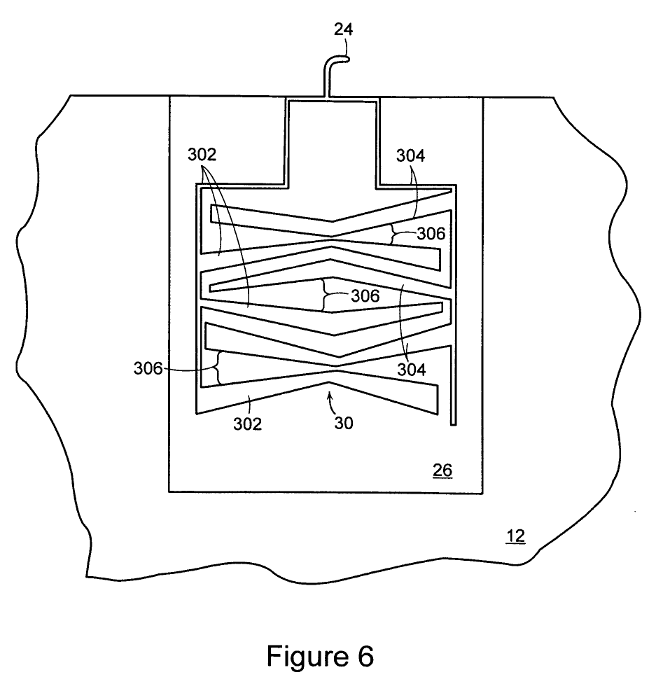

FIG. 6 is a plan view of the defrost activation sensor 30 in accordance with one embodiment of the present invention. The sensor 30 includes a first conductor 302 and a second conductor 304 that are disposed on a substrate 26 and further disposed on or within a surface 12, such as preferably an automotive window. The first conductor 302 and second conductor 304 are in electrical communication with the processor 22 via the signal carrier 24, which, as previously noted performs a variety of functions including power supply to the sensor 30. In operation, the first conductor 302 is maintained at a first potential and the second conductor is maintained at a second potential wherein the first potential is greater than the second potential. The potential difference creates an electric field, which between the first conductor 302 and the second conductor 304, results in a measurable capacitance as described above.

The first conductor 302 and the second conductor 304 are arranged in a fringing field configuration, as discussed above. In particular, each of the first conductor 302 and the second conductor 304 includes a plurality of fingers that are interlaced as shown. Each of the fingers is variable in width and defines plurality of gaps 306 between the first conductor 302 and the second conductor 304. As shown in FIG. 4, the relative size of the gap 306 between a pair of fingers is proportional to the relative width of the fingers themselves such that where the first conductor 302 and the second conductor 304 are wide, the gap 306 there between is also wide so as to better measure the dielectric constant of thicker sheets of frost, ice or snow.

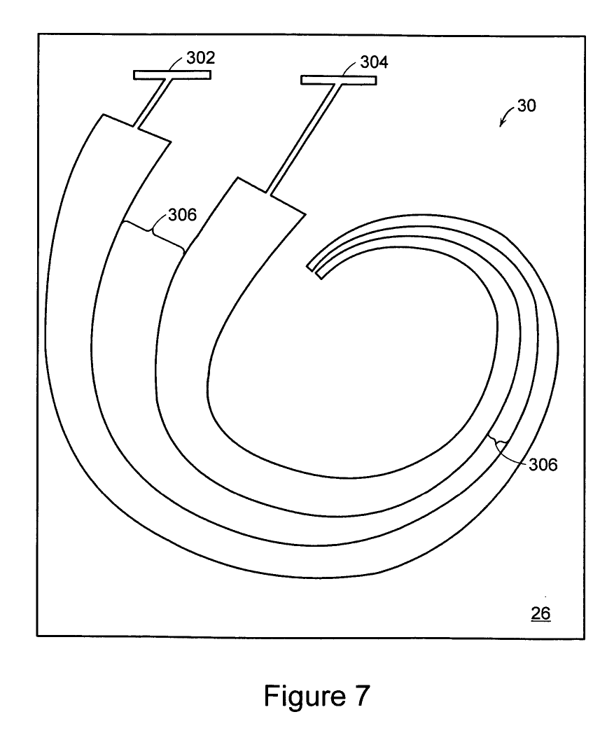

FIG. 7 is a plan view of the defrost activation sensor 30 in accordance with another embodiment of the present invention. The sensor 30 includes a first conductor 302 and a second conductor 304 that are disposed on a substrate 26 and further disposed on or within a surface 12, such as preferably an automotive window as noted above. The first conductor 302 and second conductor 304 configured for electrical communication with the processor 22 via the signal carrier 24, which, as previously noted supplies power to the sensor 30 in order to maintain the potential difference between the first conductor 302 and the second conductor 304.

In the embodiment shown in FIG. 7, each of the first conductor 302 and the second conductor 304 is configured in a spiral form that tapers along its length such that it is not of uniform width throughout. Additionally, as shown in FIG. 5, the relative size of the gap 306 between the first conductor 302 and the second conductor 304 diminishes in size proportionally with the taper of the conductors themselves. As noted above, the variable widths of the first conductor 302 and the second conductor 304 as well as the variable size of the gap 306 there between enable the sensor 30 of the present invention to better measure the dielectric constants of frost, snow and differing thicknesses of ice.

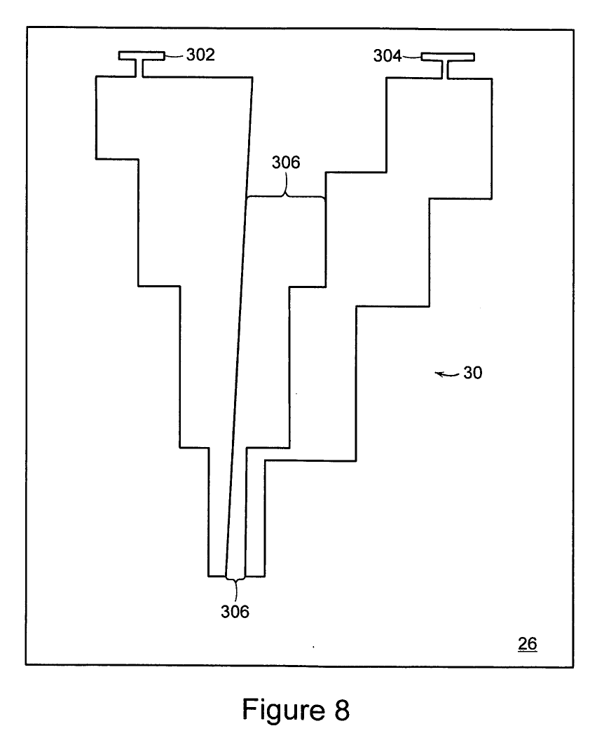

FIG. 8 is a plan view of the defrost activation sensor 30 in accordance with another embodiment of the present invention. As in the previous embodiments, the sensor 30 includes a first conductor 302 and a second conductor 304 arranged such that the gap 306 there between is variable. The first conductor 302 is linear in shape and includes a series of segments of variable width. The second conductor 304 is nonlinear in shape and includes a corresponding series of segments of variable width such that when arranged as shown in FIG. 8, the first conductor 302 and second conductor 304 will have matching segments of width corresponding to similarly sized gaps 306 defined there between. Also as noted above, the sensor 30 of FIG. 8 is preferably coupled to the processor 22 via the signal carrier 24, which in part functions to maintain the capacitance of the sensor 30.

Although various embodiments of the sensor 30 of the present invention have been presented, it should be understood that the relative geometries of the conductors and the gaps shown above are largely a matter of design choice, production costs and type of performance sought. While a preferred sensor 30 according to the present invention employs an interlaced structure as shown in FIG. 6, the other embodiments shown are equally functional and embody the necessary electrical and physical characteristics of the present invention.

Similarly, although the system and sensor of the present invention have been particularly described with reference to preferred embodiments, it is understood that simple modifications of the present invention can be readily devised by those skilled in the art without departing from the spirit and scope of the present invention set forth in the following claims.

1. A defrost activation sensor comprising:
a substrate disposable between a first pane of glass and a second pane of glass;
a first conductor disposed on the substrate, the first conductor configured to maintain a first potential;
a second conductor disposed on the substrate adjacent to the first conductor, the second conductor configured to maintain a second potential wherein the first potential is greater than the second potential; and
a processor coupled to the first conductor and the second conductor, the processor adapted to determine a deviation in a capacitance defined by the first conductor and the second conductor, the processor further adapted to activate defrosting means in response to a predetermined variance in the capacitance.

2. The sensor of claim 1 wherein the defrost means includes heated air directed at the first and second panes of glass.

3. The sensor of claim 1 wherein the defrost means includes electronic heaters adapted for heating the first and second panes of glass.

4. The sensor of claim 2 wherein the processor is coupled to an engine generating heated air.

5. The sensor of claim 4 wherein the engine is coupled to an HVAC system, the HVAC system configured for directing heated air at the first and second panes of glass.

6. The sensor of claim 1 wherein the processor is coupled to a remote starter, the remote starter adapted to receive remote signals and engage the processor to measure the capacitance in response to the remote signals.

7. The sensor of claim 1 wherein the first pane of glass and the second pane of glass define an automotive window.

8. The sensor of claim 1 wherein the first and second conductors define a length and a width and wherein the width of the first and second conductors varies along the length of the first and second conductors.

9. The sensor of claim 1 further comprising a gap defined between the first and second conductors.

10. The sensor of claim 7 wherein the gap between the first and second conductors is variable.

11. The sensor of claim 9 wherein the gap between the first and second conductors varies in proportion to the respective widths of the first and second conductors.

12. A system for automatic defrosting comprising:
a sensor disposed between a first and a second pane of glass is adapted to transmit a signal indicative of a capacitance, the capacitance being indicative of moisture on a surface;
heating means configured to heat the surface; and
a processor coupled to the sensor, the processor adapted to determine the presence of moisture on the surface in response to a predetermined capacitance signal from the sensor.

13. The system of claim 12 wherein the surface comprises a first pane of glass and a second pane of glass that form an automotive window.

14. (canceled)

15. The system of claim 12 wherein the sensor comprises a substrate, a first conductor disposed on the substrate, and a second conductor disposed on the substrate adjacent to the first conductor.

16. The system of claim 15 wherein the first conductor is configured to maintain a first potential and the second conductor is configured to maintain a second potential wherein the first potential is greater than the second potential.

17. The system of claim 12 wherein the heating means comprises heated air generated by an engine directed at the surface through an HVAC system.

18. The system of claim 12 wherein the heating means comprises electronic heaters adapted for heating the surface.

19. The system of claim 15 wherein the first and second conductors define a length and a width and wherein the width of the first and second conductors varies along the length of the first and second conductors.

20. The system of claim 15 further comprising a gap defined between the first and second conductors.

21. The system of claim 20 wherein the gap between the first and second conductors is variable.

22. The system of claim 20 wherein the gap between the first and second conductors varies in proportion to the respective widths of the first and second conductors.

23. The system of claim 15 wherein the first conductor defines a first length and a first plurality of fingers projecting from the first length.

24. The system of claim 23 wherein the second conductor defines a second length and a second plurality of fingers projecting from the second length.

25. The system of claim 15 wherein the first conductor defines a first spiral and the second conductor defines a second spiral, the first and second spiral arranged on the substrate in a concentric manner.

26. The system of claim 12 further comprising a remote starter coupled to the processor, the remote starter adapted to receive remote signals and engage the processor to measure the capacitance in response to the remote signals.

27. The sensor of claim 1 wherein the sensor is not in direct contact with moisture.

28. The system of claim 12 wherein the sensor is not in direct contact with moisture.
